(19) United States
(12) Patent Application Publication
(10) Pub. No.: US 2018/0272635 A1
(43) Pub. Date: Sep. 27, 2018

(54) METHOD AND APPARATUS FOR MAKING A CONVEYOR BELT

(71) Applicant: ContiTech Transportbandsysteme GmbH, Hannover (DE)

(72) Inventors: Andreas Jungk, Hofheim (DE); Florian Wiegmann, Hannover (DE)

(21) Appl. No.: 15/993,249

(22) Filed: May 30, 2018

Related U.S. Application Data
(63) Continuation of application No. PCT/EP2016/069760, filed on Aug. 22, 2016.

(30) Foreign Application Priority Data
Nov. 30, 2015 (DE) 102015223796.6

(51) Int. Cl. B29D 29/06; B29C 35/02; B30B 1/32; B30B 15/16; B30B 15/18

(52) U.S. Cl. CPC B29D 29/06; B29C 35/02; B30B 15/186; B30B 15/166; B30B 1/32

(57) ABSTRACT

The invention relates to a method for making conveyor belts in an apparatus having a vulcanizing press. The method minimizes the press opening times and the throughput of the press is thus optimized. With the method, a check is made during the method whether a conveyor belt blank is present for vulcanizing in the press, and depending on the information from this check, the decision is made as to how far the press opens the press plates. Here, an operating open position and a full opening of the press are provided.

### CROSS REFERENCE TO RELATED APPLICATION

This application is a continuation application of international patent application PCT/EP2016/069760, filed Aug. 22, 2016, designating the United States and claiming priority from German application 10 2015 223 796.6, filed Nov. 30, 2015, and the entire content of both applications is incorporated herein by reference.

### FIELD OF THE INVENTION

The invention relates to a method for making conveyor belts in an apparatus having a vulcanizing press having an infeed end and an outfeed end, wherein the vulcanizing press includes a press upper part and a press lower part, wherein the press upper part and the press lower part have in each case one press plate which press plates are fastenable to the respective press part, the press plates being disposed in planes that are mutually parallel, wherein the press upper part in relation to the press lower part is to be spaced apart in a manner perpendicular to the plate plane by means of a lifting assembly.

### BACKGROUND OF THE INVENTION

Press systems of this type are used in the making of flat conveyor belts. The press upper part herein is initially opened in relation to the press lower part, that is, in the normal of the plate plane is spaced apart from the press lower part in such a manner that a conveyor belt blank is able to be threaded between the press plates.

When the entire plane of the press plates is covered by the conveyor belt blank, the latter is compressed and vulcanized between the press plates on the press upper part and press lower part. When the vulcanizing process is terminated the press opens again and a further portion of the conveyor belt is able to be drawn in between the press plates.

However, since threading of the belt is required only when a new conveyor belt commences, full opening of the press is not required every time.

### SUMMARY OF THE INVENTION

An object of the invention is to provide a method of the type described above wherein the press opening times are minimized and the throughput of the press is thus optimized.

This object can, for example, be achieved by a method including the following method steps:

a) checking whether a conveyor belt blank is present for vulcanizing in the press, and transferring the item of information to an evaluation and control unit;

b) if no conveyor belt blank is present for vulcanizing in the press the control unit controls the lifting installation such that the press is fully opened and a conveyor belt blank is able to be threaded thereinto;

c) if a conveyor belt blank is present for vulcanizing in the press the control unit controls the lifting installation such that the press is fully opened to a predefined operating opening position;

d) drawing the conveyor belt into the press by a predefined length;

e) lowering the press upper part toward the lower part by means of the lifting assembly, the controller herein controlling the travel path so as to depend on the conveyor belt blank thickness measured;

f) vulcanizing;

g) checking whether a conveyor belt blank is present for vulcanizing in the press, and transferring the item of information to the evaluation and control unit;

h) if a conveyor belt blank is present for vulcanizing in the press the method is continued at step c); and,

i) if no conveyor belt blank is present for vulcanizing in the press the control unit controls the lifting assembly such that the press is fully opened, the completely vulcanized conveyor belt being removed, and restarting being able to commence.

By way of a method of this type it is possible for the press to be opened only so far per operating stroke that an onward transportation of the conveyor belt by the press plates is just possible. Full opening of the press is thus only required when threading a new conveyor belt blank, or in the case of maintenance works.

The invention furthermore relates to an apparatus for carrying out the abovementioned method, wherein the apparatus includes a vulcanizing press having a press upper part and a press lower part, wherein the press upper part and the press lower part have in each case one press plate which press plates are fastenable to the respective press part and are disposed in planes that are mutually parallel, wherein the press upper part in relation to the press lower part is to be spaced apart in a manner perpendicular to the plate plane by a lifting unit.

Another object of the invention is to configure the apparatus in such a manner that the abovementioned method can be carried out.

This object can, for example, be achieved in that the apparatus has a controller and measuring means, wherein it is testable by a first and/or a second measuring means whether a conveyor belt blank is present for vulcanizing in the press, and the mutual spacing of the press plates of the apparatus is measurable by one or a plurality of further measuring means, wherein the lifting assembly by the controller is actuatable in such a manner that predefined mutual positions of the press plates are attainable by the lifting unit.

Since an apparatus of this type is comparatively readily retrofittable to commercially available presses, conventional vulcanizing presses can be utilized for the abovementioned method. A more efficient utilization of the presses is possible on account of the minor spacings of the press plates when opened in continuous operation.

In one embodiment of the invention, the controller has mechanical measuring means.

Mechanical measuring means have the advantage that they in most instances are of a simple construction and optionally enable a direct valve activation in order for the press hydraulics to be regulated.

In one embodiment of the invention, the controller has optical measuring means.

Optical measuring means have the advantage that they measure more accurately and in a non-contacting manner such that the measured result is not tainted by mechanical clearances.

### BRIEF DESCRIPTION OF THE DRAWINGS

The invention will now be described with reference to the drawings wherein:

FIG. 1 shows a flow diagram of the method according to the invention;

FIG. 2 is a schematic of an apparatus according to the invention, having a closed pressing space;

FIG. 3 is a schematic of an apparatus according to the invention, having an operating open pressing space; and,

FIG. 4 is a schematic of an apparatus according to the invention, having a fully opened pressing space.

### DESCRIPTION OF THE PREFERRED EMBODIMENTS OF THE INVENTION

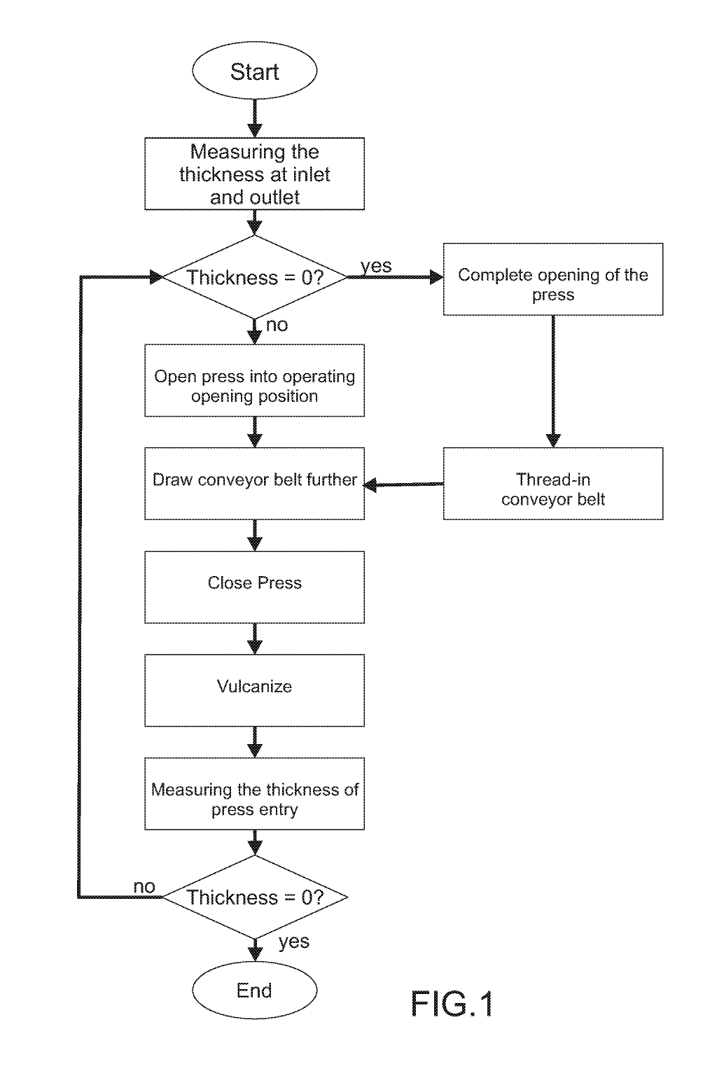

For improved clarity, the method steps a) to i) in FIG. 1 are shown in abbreviated form in a schematic flow diagram.

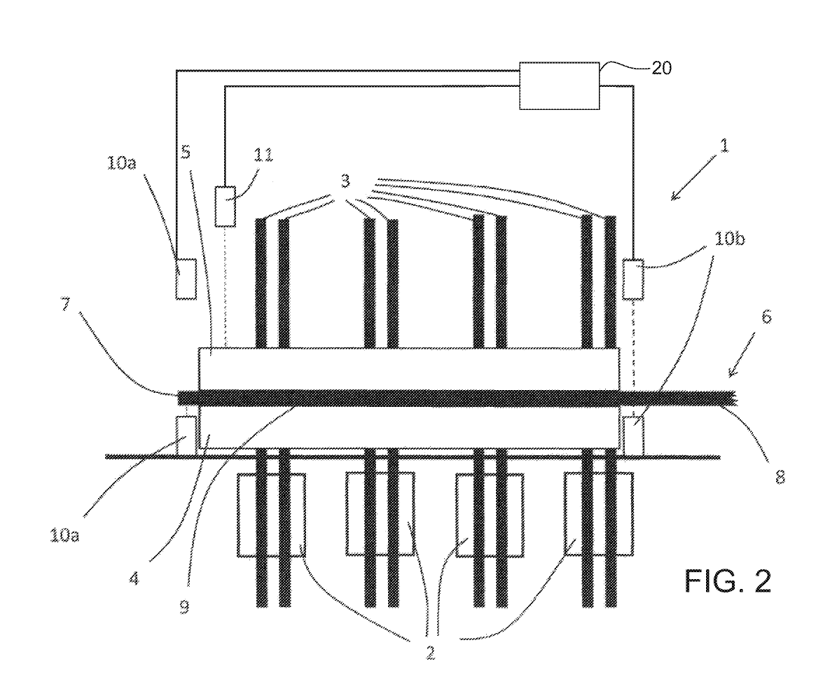

The apparatus shown in FIG. 2 has a vulcanizing press 1. The vulcanizing press 1 has four hydraulic cylinder units 2, each having two hydraulic cylinders 3. The hydraulic cylinders 2 here are electrically connected to an electrical evaluation and control unit (not shown here). The press 1 furthermore has a lower press table 4 and a press upper part 5. The press table 4 and the upper part 5 are mutually disposed so as to be in parallel planes. The hydraulic cylinders 3 are connected to the press upper part 5. A conveyor belt 6 is disposed between the press table 4 and the press upper part 5, the conveyor belt in a first part 7 being completely vulcanized, in a second part 8 being in the blank state, and in a third part 9 being clamped between the press table 4 and the press upper part 5. The press table 4 and the press upper part 5, visualized in a simplified manner here, act as press plates and are heatable by way of a heating system (not shown here). The conveyor belt 6 in the region 9 between the press plates 4 and 5 is capable of vulcanization in a known manner. The more intricate details pertaining to the vulcanization are known and therefore not shown here for reasons of simplification.

Each part 7 and 8 of the conveyor belt 9 is assigned one light gate 10a, 10b, the latter being shown here schematically. The light gates 10a and 10b are connected to the electrical control unit 20. It is testable by way of the light gates 10a, 10b whether a conveyor belt blank 6, 8 is present for vulcanizing in the press. The position of the press upper part 5 is measurable by way of a spacing measurement device 11.

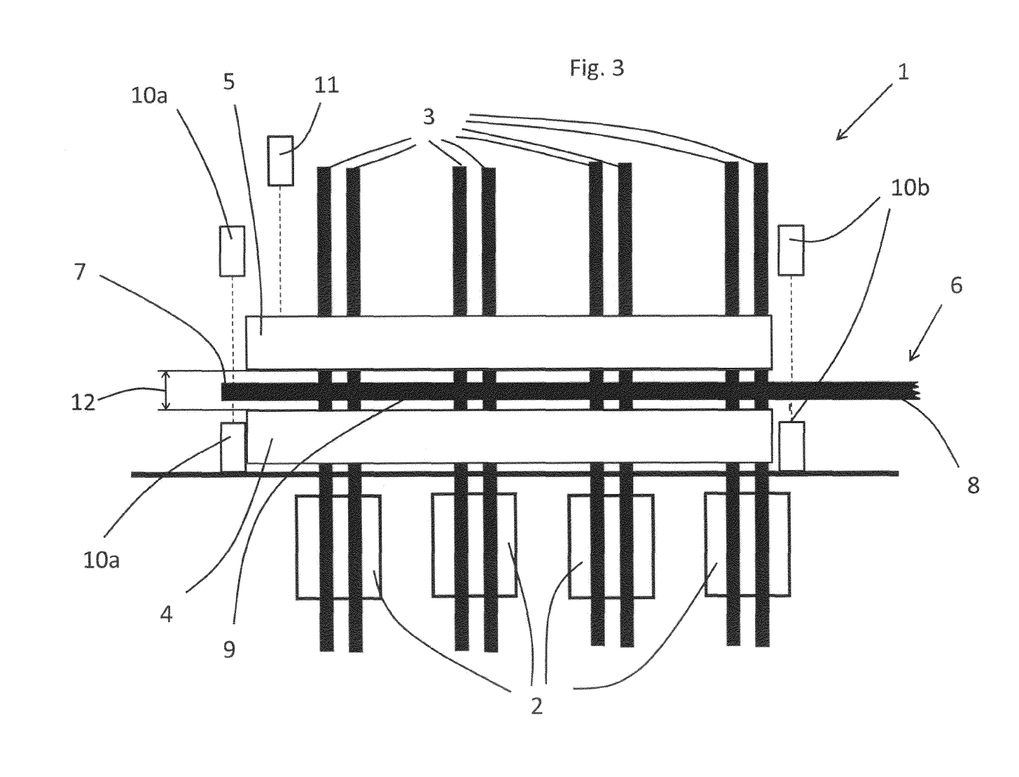

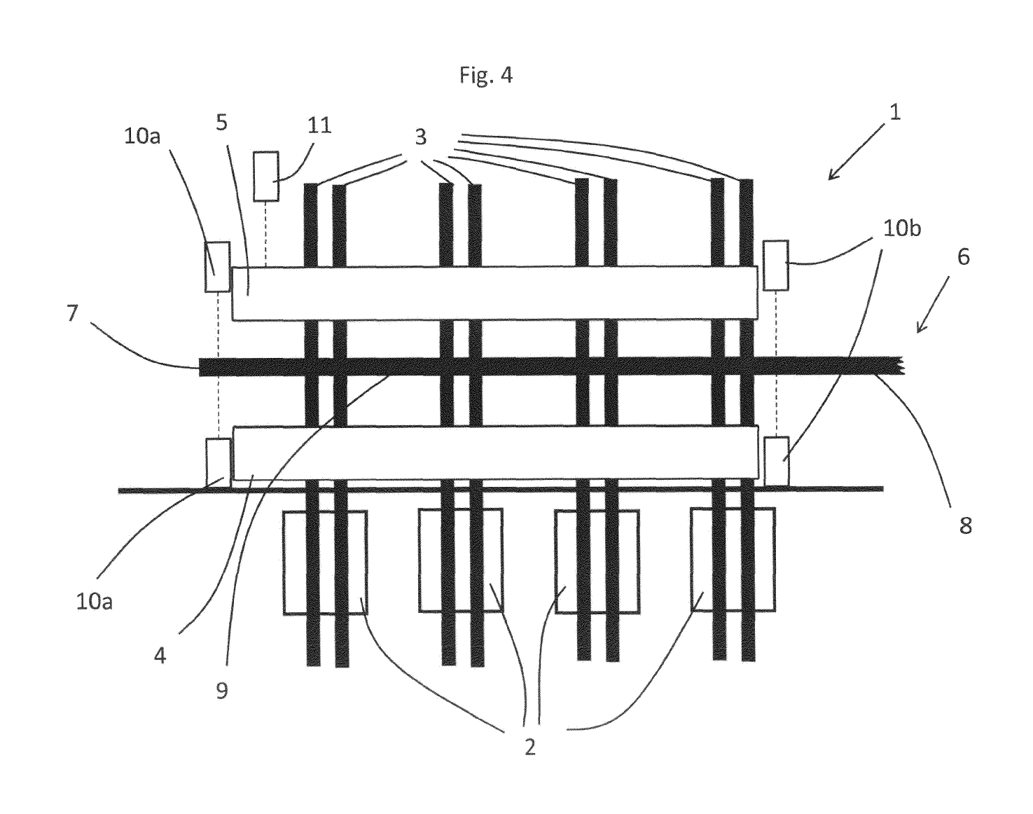

FIGS. 3 and 4 show the device in various states of opening. The press in FIG. 3 is opened in an operating position so that the conveyor belt 6 is capable of being drawn through between the press plates 4 and 5. The internal spacing 12 of the press plates 4 and 5 is set such that the conveyor belt 6 is just movable at slight clearance between the press plates 4 and 5.

The press 1 in FIG. 4 is shown in the maintenance position, so as to be fully opened.

According to the method of the invention, the light gates 10a and 10b initially measure whether a conveyor belt blank 6, 8 is present for vulcanizing in the press 1. The control unit acquires the measured values of the light gates 10a and 10b. If there is no conveyor belt 6 present, the control unit controls the lifting cylinder units 2, wherein the latter lift the press upper part 5 to the topmost position. The press 1 according to FIG. 4 is now open for maintenance works or for threading a new conveyor belt blank.

If a conveyor belt blank 6, 8 is introduced into the press, this will be measured by the light gates 10a and 10b. The measured values are acquired by the control unit 20; the lifting cylinder units 2 move the press plates 4 and 5 to the closed position according to FIG. 2. The conveyor belt blank 6, 8 is now vulcanized in a known manner. After the vulcanization has been terminated, the light gates 10a and 10 b again measure whether a conveyor belt blank 6, 8 is present for vulcanizing in the press 1. Should this be the case, the control unit 20 controls the lifting cylinder 2; the press part 5 is opened to the operating position according to FIG. 3. The conveyor belt blank 6 can now be drawn onward by one cycle length.

If a conveyor belt blank 6, 8 is no longer present for vulcanizing in the press 1, the press by way of the controller and the lifting cylinders 2 is fully opened to the maintenance position according to FIG. 4. The method can then recommence.

It is understood that the foregoing description is that of the preferred embodiments of the invention and that various changes and modifications may be made thereto without departing from the spirit and scope of the invention as defined in the appended claims.

### LIST OF REFERENCE SIGNS

### Part of the Specification

1 Vulcanizing press
2 Hydraulic cylinder units
3 Hydraulic cylinder, lifting cylinder
4 Press table, press plate
5 Press upper part, press plate
6 Conveyor belt
7, 8, 9 Regions of the conveyor belt 6
10a Light gate at the press outfeed
10b Light gate at the press infeed
11 Spacing measurement device
12 Internal spacing of the press plates 4, 5
20 Evaluation and control unit

What is claimed is:

1. A method for making a conveyor belt in an apparatus having a vulcanizing press having an infeed end and an outfeed end, wherein the vulcanizing press includes a press upper part and a press lower part, wherein the press upper part and the press lower part have respective press plates which are fastenable to the corresponding ones of the press parts, the press plates being disposed in respective planes that are mutually parallel, wherein the press upper part in relation to the press lower part is to be spaced apart in a manner perpendicular to the plate plane by a lifting assembly, the method comprising the steps of:
a) checking whether a conveyor belt blank is present for vulcanizing in the press, and transferring the item of information to an evaluation and control unit;
b) if no conveyor belt blank is present for vulcanizing in the press, then controlling, via the control unit, the lifting assembly such that the press is fully opened and a conveyor belt blank is able to be threaded thereinto;
c) if a conveyor belt blank is present for vulcanizing in the press, then controlling, via the control unit, the lifting assembly so as to cause the press to be fully opened to a predefined operating opening position;
d) drawing the conveyor belt into the press by a predefined length;
e) lowering the press upper part toward the press lower part via the lifting assembly, wherein the control unit controls the travel path in dependence upon the conveyor belt blank thickness measured;
f) vulcanizing;
g) checking whether a conveyor belt blank is present for vulcanizing in the press, and transferring the item of information to the evaluation and control unit;
h) if a conveyor belt blank is present for vulcanizing in the press, continuing the method at step c); and,
i) if no conveyor belt blank is present for vulcanizing in the press, controlling the lifting assembly via the control unit so as to cause the press to be fully opened, the completely vulcanized conveyor belt to be removed, and to be able to start anew.

2. An apparatus for carrying out a method for making a conveyor belt, the apparatus comprising:
a vulcanizing press having an infeed end and an outfeed end;
said vulcanizing press further including a press upper part and a press lower part;
said press upper part and said press lower part having respective press plates which are fastenable to the respective press parts and are disposed in planes that are mutually parallel;
a lifting assembly for causing said press upper part in relation to said press lower part to be spaced apart perpendicular to said plate planes;
a first and/or second measuring device;
a third measuring device;
a control unit receiving information from said first and/or second measuring device as to whether a conveyor belt blank is present for vulcanizing in the press;
the mutual spacing of the press plates of the apparatus being measurable by said third measuring device; and,
the lifting assembly being actuatable by the control unit so as to cause predefined mutual positions of the press plates to be assumed via said lifting assembly.

3. The apparatus of claim 2, wherein the control unit has mechanical measuring means.

4. The apparatus of claim 2, wherein the control unit has optical measuring means.
